(19) United States
(12) Patent Application Publication
(10) Pub. No.: US 2021/0316711 A1
(43) Pub. Date: Oct. 14, 2021

(54) AUTOMATICALLY ADJUST HVAC, WINDOW AND SEAT BASED ON HISTORICAL USER'S BEHAVIOR

(71) Applicant: NIO USA, Inc., San Jose, CA (US)

(72) Inventors: An Wu, San Jose, CA (US); Matthew J. Daigle, Sunnyvale, CA (US); Sama Aghniaey, San Jose, CA (US); Anqi Wang, San Jose, CA (US); Bruno M. Barthelemy, Los Gatos (US)

(21) Appl. No.: 16/844,766

(22) Filed: Apr. 9, 2020

(51) Int. Cl. B60W 10/30; B60W 40/08; B60N 2/56; B60W 50/00; B60H 1/00

(52) U.S. Cl. CPC B60W 10/30; B60W 40/08; B60H 1/00007; B60W 50/0098; B60N 2/56

(57) ABSTRACT

Embodiments are directed to controlling a thermal environment inside a cabin of a vehicle by detecting a user in the cabin of the vehicle and retrieving a profile for the detected user. The profile can define settings for each of one or more features of the vehicle influencing the thermal environment inside the cabin of the vehicle. A set of current environmental conditions can be detected and a setting for each of the one or more features of the vehicle influencing the thermal environment inside the cabin of the vehicle can be determined based on the retrieved user profile and the detected set of current environmental conditions. The determined settings can then be applied to each of the one or more features of the vehicle influencing the thermal environment inside the cabin of the vehicle.

### FIELD

The present disclosure is generally directed to vehicle climate control systems and in particular toward adjusting aspects of vehicle climate control based on current conditions and past behavior of a user related to those aspects of vehicle climate control.

### BACKGROUND

User thermal comfort in car cabins has been a very important aspect of user comfort and user experience especially in electric and autonomous vehicles. To facilitate autonomous driving, almost all functions of a vehicle should be automated, as much as possible. Currently, users can adjust the Heating, Ventilating, and Air Conditioning (HVAC) system settings and change the thermal environment in cabin using manually adjustable air temperature (relative or absolute) and blower level set points. Users can also control or influence the cabin conditions by opening and closing the windows of the vehicle or adjusting seat heating and ventilation, if the vehicle is so equipped. However, relying exclusively on manual adjustments in this way requires the user to remember comfortable setting for any given environmental conditions and/or requires repeated trial and error adjustment of the controls. Such constant adjustment can be burdensome and even dangerous if it distracts the user when driving the vehicle. Hence, there is a need in the art for improved methods and systems for vehicle climate control.

### BRIEF DESCRIPTION OF THE DRAWINGS

FIG. 1 illustrates a view of a vehicle in which embodiments of the present disclosure may be implemented.

FIG. 2 is a block diagram illustrating elements of an exemplary climate control system for a vehicle according to one embodiment of the present disclosure.

FIG. 3 is a block diagram illustrating additional details of a climate control system according to one embodiment of the present disclosure.

FIG. 4 is a flowchart illustrating an exemplary process for climate control in a vehicle according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

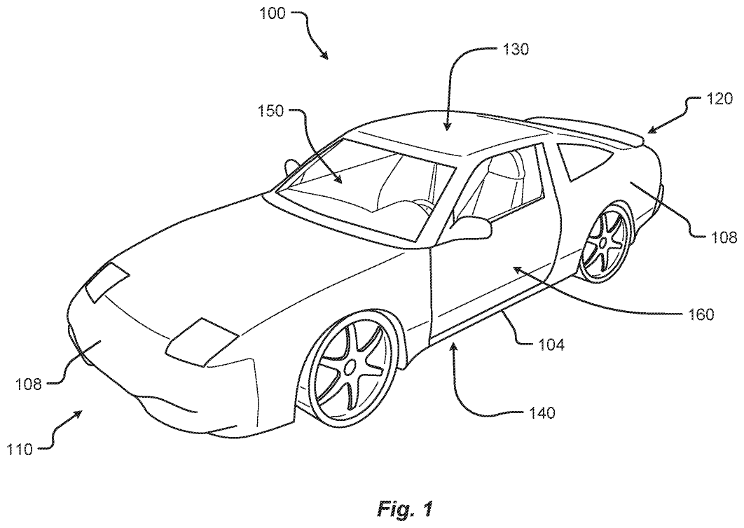

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

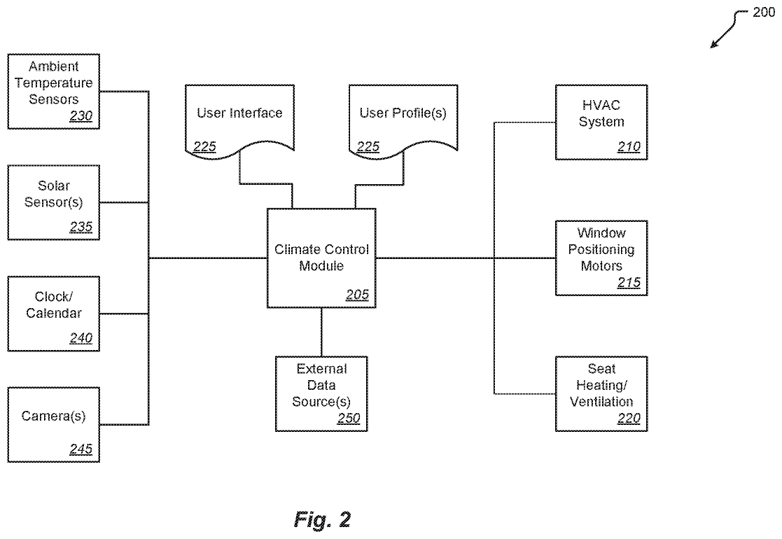

FIG. 2 is a block diagram illustrating elements of an exemplary climate control system for a vehicle according to one embodiment of the present disclosure. As illustrated in this example, a climate control system 200 of a vehicle 100 can comprise a climate control module 205 which controls a Heating Ventilating and Air Conditioning (HVAC) system of the vehicle 100 including, but not limited to one or more heaters, an air conditioning system, one or more blowers, louvers of an air duct system, etc. Generally speaking, the climate control module 205 can control these elements of the HVAC system 210 to regulate a thermal environment inside of the vehicle 100. This control can be based on input from a user interface 215 and any number of sensors. As will be described in greater detail below, these sensors can include, but are not limited to, a plurality of ambient temperature sensors 230, one or more solar sensors 235, a clock and/or calendar 240, and/or one or more cameras 245. In some cases, and as will be described below, the climate control module 205 may also control additional features of the vehicle 100 influencing the thermal environment in the cabin of the vehicle 100. For example, the climate control system may control one or more window positioning motors 215 and/or one or more seat heating and/or ventilation systems 220. The one or more window positioning motors 215 and/or one or more seat heating and/or ventilation systems 220 can be controlled by the climate control system 205 automatically as described herein or in response to manual input through the user interface 225.

Generally speaking, the climate control module 205 can be adapted to maintain a profile 255 for each user of the vehicle 100. Each profile 255 can define preferred HVAC, seat heating and/or ventilation, and/or window position settings of each user for various ambient thermal conditions and cabin thermal conditions. These profiles 255 can be defined and/or updated in a number of different ways. For example, settings for the HVAC system, windows, and/or seat heating and/or ventilation for various conditions can be received from the user through the user interface 225, though an online service in communications with the climate control module 205, through a mobile device or other computing device in communication with the climate control module 205, etc. In another example, the profile 255 for the user can be defined based on data from a remote or external data source 250 through the communication interfaces 320. The data can be collected and maintained by the remote or external data source 250 from user profiles of other users of vehicles, e.g., in the geographic region as the user. In yet another example, the profile 255 for the user can be based on a history of past manual settings entered by the user, e.g., through the user interface 225.

When a user enters the vehicle 100, the climate control module 205 can detect that user, e.g., using images from one or more cameras 245 in the vehicle 100 and facial recognition processes as known in the art. In other cases, the user can be detected and identified using various biometric sensors (not shown here) or based on a mobile device carried by the user and detected by the climate control module 205. Once the user is detected, the climate control module 205 can load the profile 255 for that user and check the current environmental conditions using one or more sensors including, but not limited to, one or more ambient temperature sensors 230 in or on the vehicle to detect temperature inside the cabin and/or outside of the cabin, one or more solar sensors 235 to detect and/or determine a level of solar heating of the cabin of the vehicle, etc. In some cases, the settings defined in the profile may be further based on a time of day and/or season. In such cases, the climate control module 205 may also access a clock and/or calendar to determine a current time and date.

In some cases, more than one user may be present in the vehicle 100 at any given time. In such cases, and according to one embodiment, more than one profile 255 can be retrieved and used by the climate control module 205. That is, the climate control module 205 can detect a plurality of users and retrieve a profile 255 for each of the detected users. The settings can then be determined by the climate control module 205 based on each of these profiles 255. For example, the profiles 255 can be applied to different zones within the cabin of the vehicle 100 depending on where each detected user is located. In other cases, common settings between the profiles, if any, can be used while differences can be resolved by using intermediate or average values between the profiles, preferences or priorities assigned to the profiles, etc.

In some cases, once the settings have been determined, they can be applied by the climate control module 205 to automatically control the HVAC system 210, window positioning motors 215, and/or seat heating and/or ventilation systems 220. In other cases, a notification can be by the climate control system 205, e.g., through the user interface, to inform the user of the settings to be applied. In such cases, the user may be given options to accept or modify the determined settings through the user interface 225. If the user accepts the settings, they can be applied by the climate control module 205 to automatically control the HVAC system 210, window positioning motors 215, and/or seat heating and/or ventilation systems 220. If the user adjusts the settings, the adjusted can be applied by the climate control module 205 to automatically control the HVAC system 210, window positioning motors 215, and/or seat heating and/or ventilation systems 220 and the user profile 255 can be updated based on the adjustments, e.g., by applying a behavior learning algorithm.

Once settings have been applied, the climate control module 205 can continue to monitor the current environmental conditions in and around the cabin of the vehicle 100 and may adjust the settings based on changes in the conditions, i.e., determine new settings for the HVAC, window position, and/or seat heating and/or ventilation, based on the new conditions. Additionally, or alternatively, the user may request a change in the settings, e.g., via a manual adjustment through the user interface 225. In such cases, the climate control module 205 can then enter a manual mode to allow the user to override the automatic settings, receive the new settings from the user, and apply the new settings to control the HVAC system 210, window positioning motors 215, and/or seat heating and/or ventilation systems 220. The user profile 255 can then be updated based on the new settings, e.g., by applying a behavior learning algorithm.

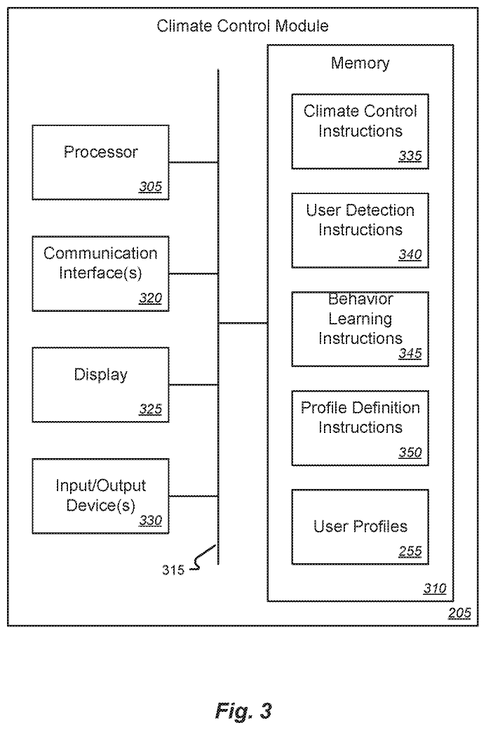

FIG. 3 is a block diagram illustrating additional details of a climate control system according to one embodiment of the present disclosure. As illustrated in this example, a climate control module 205 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the climate control module 205 as described herein.

A memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 and a display 325 via the communications bus 315. The communication interfaces 320 can comprise, for example, a Bluetooth, WiFi, or other type of wireless communications interface, for example for communicating with wearable and/or mobile devices of the users within the vehicle. In some cases, the communication interfaces 320 can also include an interface for communicating via a wireless network. The display 325 can comprise, for example, a Liquid Crystal Display (LCD), Light Emitting Diode (LED), Organic Light Emitting Diode (OLED), Plasma Display Panel (PDP), Cathode Ray Tube (CRT) display or other type of display for presenting a climate control user interface 215 as described above. Any number of input/output devices 330, including, but not limited to, the ambient temperature sensors 230, solar sensor(s) 235, a clock/calendar, and/or camera(s) 245 can also be coupled with the communications bus 315.

The memory 310 can store therein sets of instructions which, when executed by the processor 305, cause the processor 305 to control an HVAC system 210 of a vehicle 100 as described herein. More specifically, the memory 310 can store one or more user profiles 255 for users of the vehicle 100. Each profile 255 can define a plurality of settings for each of one or more features of the vehicle 100 influencing the thermal environment inside the cabin of the vehicle 100. For example, the one or more features of the vehicle 100 influencing the thermal environment inside the cabin of the vehicle comprise one or more of an HVAC system 210, one or more window positioning motors 215, or one or more seat heating and/or ventilating system 220.

The memory 310 can also store therein a set of profile definition instructions 350 which, when executed by the processor 305, causes the processor 305 to define and/or update the user profiles 255. For example, defining the profile for the user can comprises receiving, from the user, the plurality of settings for each of the one or more features of the vehicle influencing the thermal environment inside the cabin of the vehicle 100. This can be accomplished through user interface 225 of a climate control module 205 presented through the display 325, though an online service accessing the climate control module 205 through the communication interfaces 320, through a mobile device or other computing device communicating with the climate control module 205 through the communication interfaces 320, etc. In another example, defining the profile for the user can comprise receiving data from a remote or external data source 250 through the communication interfaces 320. The data can be collected and maintained by the remote or external data source 250 from user profiles of other users of vehicles and the profile for the user can be defined based on the received data from the remote data source. In yet another example, defining the profile for the user can be based on a history of past settings for one or more of the plurality of settings for each of the one or more features of the vehicle 100 influencing the thermal environment inside the cabin of the vehicle 100.

The memory can also store a set of user detection instructions 340. The user detection instructions 340, when executed by the processor 305, can cause the processor 305 to detect a user when the user enters the vehicle 100, e.g., through one or more of the input output devices 330 such as a camera 245 and using facial recognition processes as known in the art, for example. In response, the user detection instructions 335 can cause the processor 305 to retrieve or load the profile for the detected user.

The memory can also store a set of climate control instructions 335. When executed by the processor 305, the climate control instructions 335 can cause the processor 305 to detect a set of current environmental conditions, e.g., ambient temperature, time of day, level of solar heating, etc. using input/output devices 330 such as a set of sensors in or on the vehicle 100 as described above. The climate control instructions 335 can further cause the processor 305 to determine a setting for each of the one or more features of the vehicle 100 influencing the thermal environment inside the cabin of the vehicle 100 based on the retrieved user profile and the detected set of current environmental conditions.

Once the settings have been determined, the climate control instructions 335 can cause the processor 305 to apply the determined settings to each of the one or more features of the vehicle influencing the thermal environment inside the cabin of the vehicle. Optionally, the climate control instructions 335 can cause the processor 305 to notify the user of the determined settings for each of the one or more features of the vehicle influencing the thermal environment inside the cabin of the vehicle, for example, through a user interface 225 of the climate control module 205 presented on the display 325, through a message sent by the climate control module 205 to a mobile device of the user through the communication interfaces 320, etc. This notification can be provided after the determined settings are applied or, in some cases, before the settings are applied so that the user can be given a chance to accept or adjust the settings.

Once the settings have been applied, the climate control instructions 335 can cause the processor 305 to maintain these settings based on continued monitoring of the current environmental conditions. At some point in time, a request to change the applied setting for at least one of the features of the vehicle influencing the thermal environment inside the cabin of the vehicle can be received, e.g., based on the user adjusting controls for one or more of the features. In response, the climate control instructions 335 can cause the processor 305 to switch control of the at least one or the features of the vehicle influencing the thermal environment inside the cabin of the vehicle to a manual mode and receive a new setting for the at least one of the features of the vehicle influencing the thermal environment inside the cabin of the vehicle from the user, e.g., through a user interface 225 of the climate control module 205 presented on the display. The climate control instructions 335 can cause the processor 305 to apply the new setting for the at least one of the features of the vehicle influencing the thermal environment inside the cabin of the vehicle to control the climate of the vehicle cabin. Additionally, the memory 310 can store therein a set of behavior learning instructions 345 which, when executed by the processor 305, cause the processor to update the profile 255 for the detected user based on the new setting for the at least one of the features of the vehicle influencing the thermal environment inside the cabin of the vehicle.

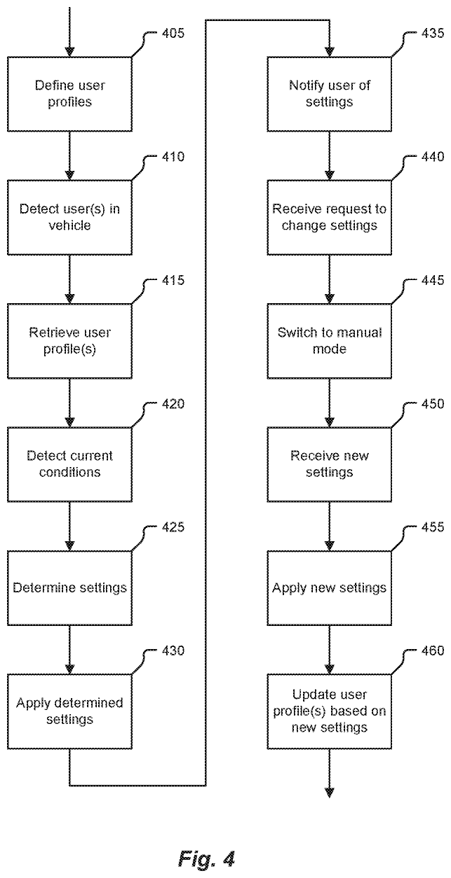

FIG. 4 is a flowchart illustrating an exemplary process for climate control in a vehicle according to one embodiment of the present disclosure. As illustrated in this example, controlling a thermal environment inside a cabin of a vehicle can begin with defining 405 a profile for each of one or more users of the vehicle 100. The profile can define a plurality of settings for each of one or more features of the vehicle 100 influencing the thermal environment inside the cabin of the vehicle 100. For example, the one or more features of the vehicle 100 influencing the thermal environment inside the cabin of the vehicle comprise one or more of an HVAC system 210, one or more window positioning motors 215, or one or more seat heating and/or ventilating system 220.

In some cases, defining 405 the profile for the user can comprises receiving, from the user, the plurality of settings for each of the one or more features of the vehicle influencing the thermal environment inside the cabin of the vehicle 100. For example, this can be accomplished through user interface 225 of a climate control module 205 of the vehicle, though an online service, through a mobile device or other computing device communicating with the climate control module 205 of the vehicle 100, etc. In other cases, defining 405 the profile for the user can comprise receiving data from a remote or external data source 250. The data can be collected and maintained by the remote or external data source 250 from user profiles of other users of vehicles and the profile for the user can be defined 405 based on the received data from the remote data source. In yet other cases, defining 405 the profile for the user can be based on a history of past settings for one or more of the plurality of settings for each of the one or more features of the vehicle 100 influencing the thermal environment inside the cabin of the vehicle 100.

When the user enters the vehicle 100, the user can be detected 410 in the cabin of the vehicle 100 and the profile for the detected user can be retrieved 415. A set of current environmental conditions, e.g., ambient temperature, time of day, level of solar heating, etc., can be detected 420, e.g., by a set of sensors in or on the vehicle 100. A setting for each of the one or more features of the vehicle 100 influencing the thermal environment inside the cabin of the vehicle 100 can be determined 425 based on the retrieved user profile and the detected set of current environmental conditions.

It should be understood that, in some cases, more than one user may be in the vehicle 100 at any given time. Accordingly, detecting 410 the user in the cabin of the vehicle can comprise detecting a plurality of users, retrieving 415 the user profile for the detected user can comprise retrieving a user profile for each of the detected plurality of users, and determining a setting for each of the one or more features of the vehicle influencing the thermal environment inside the cabin of the vehicle can be based on a combination of the user profiles for each of the detected plurality of users. For example, common settings between the profiles, if any, can be used while differences can be resolved by using intermediate or average values between the profiles, preferences or priorities assigned to the profiles, etc.

Once the settings have been determined 425, the determined settings can be applied 430 to each of the one or more features of the vehicle influencing the thermal environment inside the cabin of the vehicle. Optionally, the user can be notified 435 of the determined settings for each of the one or more features of the vehicle influencing the thermal environment inside the cabin of the vehicle, for example, through a user interface 225 of the climate control module 205, through a message send by the climate control module 205 to a mobile device of the user, etc. This notification can be provided after the determined settings are applied 430 or, in some cases, before the settings are applied 430 so that the user can be given a chance to accept or adjust the settings.

Once the settings have been applied 430, these settings can be maintained based on continued monitoring of the current environmental conditions. At some point in time, a request to change the applied setting for at least one of the features of the vehicle influencing the thermal environment inside the cabin of the vehicle can be received 440, e.g., based on the user adjusting controls for one or more of the features. In response, control of the at least one or the features of the vehicle influencing the thermal environment inside the cabin of the vehicle can be switched 445 to a manual mode and a new setting for the at least one of the features of the vehicle influencing the thermal environment inside the cabin of the vehicle can be received 450 from the user, e.g., through a user interface 225 of the climate control module 205. The new setting for the at least one of the features of the vehicle influencing the thermal environment inside the cabin of the vehicle can then be applied 455 to control the climate of the vehicle cabin. Additionally, the profile for the detected user can be updated 460 based on the new setting for the at least one of the features of the vehicle influencing the thermal environment inside the cabin of the vehicle. For example, updating 460 the profile for the detected user based on the new setting comprises applying a learning algorithm.

Embodiments include a method for controlling a thermal environment inside a cabin of a vehicle, the method comprising: detecting, by a processor of a climate control system of the vehicle, a user in the cabin of the vehicle; retrieving, by the processor of the climate control system of the vehicle, a profile for the detected user, the profile defining a plurality of settings for each of one or more features of the vehicle influencing the thermal environment inside the cabin of the vehicle; detecting, by the processor of the climate control system of the vehicle, a set of current environmental conditions; determining, by the processor of the climate control system of the vehicle, a setting for each of the one or more features of the vehicle influencing the thermal environment inside the cabin of the vehicle based on the retrieved user profile and the detected set of current environmental conditions; and applying, by the processor of the climate control system of the vehicle, the determined setting to each of the one or more features of the vehicle influencing the thermal environment inside the cabin of the vehicle.

Aspects of the above method further include receiving, by the processor of the climate control system of the vehicle, a request to change the applied setting for at least one of the features of the vehicle influencing the thermal environment inside the cabin of the vehicle; switching, by the processor of the climate control system of the vehicle, to a manual mode for controlling the at least one or the features of the vehicle influencing the thermal environment inside the cabin of the vehicle; receiving, by the processor of the climate control system of the vehicle, a new setting for the at least one of the features of the vehicle influencing the thermal environment inside the cabin of the vehicle; applying, by the processor of the climate control system of the vehicle, the new setting for the at least one of the features of the vehicle influencing the thermal environment inside the cabin of the vehicle; and updating, by the processor of the climate control system of the vehicle, the profile for the detected user based on the new setting for the at least one of the features of the vehicle influencing the thermal environment inside the cabin of the vehicle.

Aspects of the above method include wherein updating the profile for the detected user based on the new setting comprises applying a learning algorithm.

Aspects of the above method include defining, by the processor of the climate control system of the vehicle, the profile for the user.

Aspects of the above method include wherein defining the profile for the user comprises receiving, by the processor of the climate control system of the vehicle, from the user, the plurality of settings for each of the one or more features of the vehicle influencing the thermal environment inside the cabin of the vehicle.

Aspects of the above method include wherein defining the profile for the user comprises receiving, by the processor of the climate control system of the vehicle, data from a remote data source, the data collected and maintained by the remote data source from user profiles of users of a plurality of vehicles and wherein the profile for the user is defined based on the received data from the remote data source.

Aspects of the above method include wherein defining the profile for the detected user is based on a history of past settings for one or more of the plurality of settings for each of the one or more features of the vehicle influencing the thermal environment inside the cabin of the vehicle.

Aspects of the above method include wherein the one or more features of the vehicle influencing the thermal environment inside the cabin of the vehicle comprise one or more of a Heating Ventilating and Air Conditioning (HVAC) system, one or more window positioning motors, or one or more seat heating and/or ventilating systems.

Aspects of the above method further include notifying, by the processor of the climate control system, the user of the determined settings for each of the one or more features of the vehicle influencing the thermal environment inside the cabin of the vehicle.

Aspects of the above method include wherein detecting the user in the cabin of the vehicle comprises detecting a plurality of users, wherein retrieving the user profile for the detected user comprises retrieving a user profile for each of the detected plurality of users, and wherein a setting for each of the one or more features of the vehicle influencing the thermal environment inside the cabin of the vehicle is based on a combination of the user profiles for each of the detected plurality of users.

Embodiments include a climate control system of a vehicle, the climate control system comprising: a processor; and a memory, coupled with and readable by the processor and storing therein a set of instructions which, when executed by the processor, cause the processor to control a thermal environment inside a cabin of a vehicle by: detecting a user in the cabin of the vehicle; retrieving a profile for the detected user, the profile defining a plurality of settings for each of one or more features of the vehicle influencing the thermal environment inside the cabin of the vehicle, wherein the one or more features of the vehicle influencing the thermal environment inside the cabin of the vehicle comprise one or more of a Heating Ventilating and Air Conditioning (HVAC) system, one or more window positioning motors, or one or more seat heating and/or ventilating systems; detecting a set of current environmental conditions; determining a setting for each of the one or more features of the vehicle influencing the thermal environment inside the cabin of the vehicle based on the retrieved user profile and the detected set of current environmental conditions; and applying the determined setting to each of the one or more features of the vehicle influencing the thermal environment inside the cabin of the vehicle.

Aspects of the above climate control system of a vehicle include wherein the instructions further cause the processor to: receive a request to change the applied setting for at least one of the features of the vehicle influencing the thermal environment inside the cabin of the vehicle; switch to a manual mode for controlling the at least one or the features of the vehicle influencing the thermal environment inside the cabin of the vehicle; receive a new setting for the at least one of the features of the vehicle influencing the thermal environment inside the cabin of the vehicle; apply the new setting for the at least one of the features of the vehicle influencing the thermal environment inside the cabin of the vehicle; and update the profile for the detected user based on the new setting for the at least one of the features of the vehicle influencing the thermal environment inside the cabin of the vehicle, wherein updating the profile for the detected user based on the new setting comprises applying a learning algorithm.

Aspects of the above climate control system of a vehicle include wherein the instructions further cause the processor to define the profile for the user by receiving, from the user, the plurality of settings for each of the one or more features of the vehicle influencing the thermal environment inside the cabin of the vehicle.

Aspects of the above climate control system of a vehicle include wherein the instructions further cause the processor to define the profile for the user by receiving data from a remote data source, the data collected and maintained by the remote data source from user profiles of users of a plurality of vehicles and wherein the profile for the user is defined based on the received data from the remote data source.

Aspects of the above climate control system of a vehicle include wherein the instructions further cause the processor to define the profile for the user based on a history of past settings for one or more of the plurality of settings for each of the one or more features of the vehicle influencing the thermal environment inside the cabin of the vehicle.

Embodiments include a vehicle comprising: a cabin Heating, Ventilation, and Air Conditioning (HVAC) system; one or more window positioning motors; one or more seat heating and/or ventilating systems; a cabin climate control system coupled with each of the HVAC system, the one or more window positioning motors, and the one or more seat heating and/or ventilating systems, the climate control system comprising: a processor; and a memory coupled with and readable by the processor and storing therein a set of instructions which, when executed by the processor, cause the processor to control a thermal environment inside a cabin of a vehicle by: detecting a user in the cabin of the vehicle; retrieving a profile for the detected user, the profile defining a plurality of settings for each of one or more features of the vehicle influencing the thermal environment inside the cabin of the vehicle, wherein the one or more features of the vehicle influencing the thermal environment inside the cabin of the vehicle comprise one or more of a Heating Ventilating and Air Conditioning (HVAC) system, one or more window positioning motors, or one or more seat heating and/or ventilating systems; detecting a set of current environmental conditions; determining a setting for each of the one or more features of the vehicle influencing the thermal environment inside the cabin of the vehicle based on the retrieved user profile and the detected set of current environmental conditions; and applying the determined setting to each of the one or more features of the vehicle influencing the thermal environment inside the cabin of the vehicle.

Aspects of the above vehicle include wherein the instructions further cause the processor to: receive a request to change the applied setting for at least one of the features of the vehicle influencing the thermal environment inside the cabin of the vehicle; switch to a manual mode for controlling the at least one or the features of the vehicle influencing the thermal environment inside the cabin of the vehicle; receive a new setting for the at least one of the features of the vehicle influencing the thermal environment inside the cabin of the vehicle; apply the new setting for the at least one of the features of the vehicle influencing the thermal environment inside the cabin of the vehicle; and update the profile for the detected user based on the new setting for the at least one of the features of the vehicle influencing the thermal environment inside the cabin of the vehicle, wherein updating the profile for the detected user based on the new setting comprises applying a learning algorithm.

Aspects of the above vehicle include wherein the instructions further cause the processor to define the profile for the user by receiving, from the user, the plurality of settings for each of the one or more features of the vehicle influencing the thermal environment inside the cabin of the vehicle.

Aspects of the above vehicle include wherein the instructions further cause the processor to define the profile for the user by receiving data from a remote data source, the data collected and maintained by the remote data source from user profiles of users of a plurality of vehicles and wherein the profile for the user is defined based on the received data from the remote data source.

Aspects of the above vehicle include wherein the instructions further cause the processor to define the profile for the user based on a history of past settings for one or more of the plurality of settings for each of the one or more features of the vehicle influencing the thermal environment inside the cabin of the vehicle.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method for controlling a thermal environment inside a cabin of a vehicle, the method comprising:
detecting, by a processor of a climate control system of the vehicle, a user in the cabin of the vehicle;
retrieving, by the processor of the climate control system of the vehicle, a profile for the detected user, the profile defining a plurality of settings for each of one or more features of the vehicle influencing the thermal environment inside the cabin of the vehicle;
detecting, by the processor of the climate control system of the vehicle, a set of current environmental conditions;
determining, by the processor of the climate control system of the vehicle, a setting for each of the one or more features of the vehicle influencing the thermal environment inside the cabin of the vehicle based on the retrieved user profile and the detected set of current environmental conditions; and
applying, by the processor of the climate control system of the vehicle, the determined setting to each of the one or more features of the vehicle influencing the thermal environment inside the cabin of the vehicle.

2. The method of claim 1, further comprising:
receiving, by the processor of the climate control system of the vehicle, a request to change the applied setting for at least one of the features of the vehicle influencing the thermal environment inside the cabin of the vehicle;
switching, by the processor of the climate control system of the vehicle, to a manual mode for controlling the at least one or the features of the vehicle influencing the thermal environment inside the cabin of the vehicle;
receiving, by the processor of the climate control system of the vehicle, a new setting for the at least one of the features of the vehicle influencing the thermal environment inside the cabin of the vehicle;
applying, by the processor of the climate control system of the vehicle, the new setting for the at least one of the features of the vehicle influencing the thermal environment inside the cabin of the vehicle; and
updating, by the processor of the climate control system of the vehicle, the profile for the detected user based on the new setting for the at least one of the features of the vehicle influencing the thermal environment inside the cabin of the vehicle.

3. The method of claim 2, wherein updating the profile for the detected user based on the new setting comprises applying a learning algorithm.

4. The method of claim 1, further comprising defining, by the processor of the climate control system of the vehicle, the profile for the user.

5. The method of claim 4, wherein defining the profile for the user comprises receiving, by the processor of the climate control system of the vehicle, from the user, the plurality of settings for each of the one or more features of the vehicle influencing the thermal environment inside the cabin of the vehicle.

6. The method of claim 4, wherein defining the profile for the user comprises receiving, by the processor of the climate control system of the vehicle, data from a remote data source, the data collected and maintained by the remote data source from user profiles of users of a plurality of vehicles and wherein the profile for the user is defined based on the received data from the remote data source.

7. The method of claim 4, wherein defining the profile for the detected user is based on a history of past settings for one or more of the plurality of settings for each of the one or more features of the vehicle influencing the thermal environment inside the cabin of the vehicle.

8. The method of claim 1, wherein the one or more features of the vehicle influencing the thermal environment inside the cabin of the vehicle comprise one or more of a Heating Ventilating and Air Conditioning (HVAC) system, one or more window positioning motors, or one or more seat heating and/or ventilating systems.

9. The method of claim 1, further comprising notifying, by the processor of the climate control system, the user of the determined settings for each of the one or more features of the vehicle influencing the thermal environment inside the cabin of the vehicle.

10. The method of claim 1, wherein detecting the user in the cabin of the vehicle comprises detecting a plurality of users, wherein retrieving the user profile for the detected user comprises retrieving a user profile for each of the detected plurality of users, and wherein a setting for each of the one or more features of the vehicle influencing the thermal environment inside the cabin of the vehicle is based on a combination of the user profiles for each of the detected plurality of users.

11. A climate control system of a vehicle, the climate control system comprising:
a processor; and
a memory, coupled with and readable by the processor and storing therein a set of instructions which, when executed by the processor, causes the processor to control a thermal environment inside a cabin of a vehicle by:
retrieving a profile for a detected user in the cabin of the vehicle, the profile defining a plurality of settings for each of one or more features of the vehicle influencing the thermal environment inside the cabin of the vehicle, wherein the one or more features of the vehicle influencing the thermal environment inside the cabin of the vehicle comprises one or more of a Heating Ventilating and Air Conditioning (HVAC) system, one or more window positioning motors, and one or more seat heating and/or ventilating systems;
determining a setting for each of the one or more features of the vehicle influencing the thermal environment inside the cabin of the vehicle based on the retrieved user profile and a detected set of current environmental conditions; and
causing the application of the determined setting to each of the one or more features of the vehicle influencing the thermal environment inside the cabin of the vehicle.

12. The climate control system of a vehicle of claim 11, wherein the instructions further cause the processor to:
receive a request to change the applied setting for at least one of the features of the vehicle influencing the thermal environment inside the cabin of the vehicle;
switch to a manual mode for controlling the at least one or the features of the vehicle influencing the thermal environment inside the cabin of the vehicle;
receive a new setting for the at least one of the features of the vehicle influencing the thermal environment inside the cabin of the vehicle;
apply the new setting for the at least one of the features of the vehicle influencing the thermal environment inside the cabin of the vehicle; and
update the profile for the detected user based on the new setting for the at least one of the features of the vehicle influencing the thermal environment inside the cabin of the vehicle, wherein updating the profile for the detected user based on the new setting comprises applying a learning algorithm.

13. The climate control system of a vehicle of claim 11, wherein the instructions further cause the processor to define the profile for the user by receiving, from the user, the plurality of settings for each of the one or more features of the vehicle influencing the thermal environment inside the cabin of the vehicle.

14. The climate control system of a vehicle of claim 11, wherein the instructions further cause the processor to define the profile for the user by receiving data from a remote data source, the data collected and maintained by the remote data source from user profiles of users of a plurality of vehicles and wherein the profile for the user is defined based on the received data from the remote data source.

15. The climate control system of a vehicle of claim 11, wherein the instructions further cause the processor to define the profile for the user based on a history of past settings for one or more of the plurality of settings for each of the one or more features of the vehicle influencing the thermal environment inside the cabin of the vehicle.

16. A vehicle comprising:
a cabin Heating, Ventilation, and Air Conditioning (HVAC) system;
one or more window positioning motors;
one or more seat heating and/or ventilating systems;
a cabin climate control system coupled with each of the HVAC system, the one or more window positioning motors, and the one or more seat heating and/or ventilating systems, the climate control system comprising:
a processor; and
a memory coupled with and readable by the processor and storing therein a set of instructions which, when executed by the processor, causes the processor to control a thermal environment inside a cabin of a vehicle by:
detecting a user in the cabin of the vehicle;
retrieving a profile for the detected user, the profile defining a plurality of settings for each of one or more features of the vehicle influencing the thermal environment inside the cabin of the vehicle, wherein the one or more features of the vehicle influencing the thermal environment inside the cabin of the vehicle comprise one or more of a Heating Ventilating and Air Conditioning (HVAC) system, one or more window positioning motors, or one or more seat heating and/or ventilating systems;
detecting a set of current environmental conditions;
determining a setting for each of the one or more features of the vehicle influencing the thermal environment inside the cabin of the vehicle based on the retrieved user profile and the detected set of current environmental conditions; and
applying the determined setting to each of the one or more features of the vehicle influencing the thermal environment inside the cabin of the vehicle.

17. The vehicle of claim 16, wherein the instructions further cause the processor to:
receive a request to change the applied setting for at least one of the features of the vehicle influencing the thermal environment inside the cabin of the vehicle;
switch to a manual mode for controlling the at least one or the features of the vehicle influencing the thermal environment inside the cabin of the vehicle;
receive a new setting for the at least one of the features of the vehicle influencing the thermal environment inside the cabin of the vehicle;
apply the new setting for the at least one of the features of the vehicle influencing the thermal environment inside the cabin of the vehicle; and
update the profile for the detected user based on the new setting for the at least one of the features of the vehicle influencing the thermal environment inside the cabin of the vehicle, wherein updating the profile for the detected user based on the new setting comprises applying a learning algorithm.

18. The vehicle of claim 16, wherein the instructions further cause the processor to define the profile for the user by receiving, from the user, the plurality of settings for each of the one or more features of the vehicle influencing the thermal environment inside the cabin of the vehicle.

19. The vehicle of claim 16, wherein the instructions further cause the processor to define the profile for the user by receiving data from a remote data source, the data collected and maintained by the remote data source from user profiles of users of a plurality of vehicles and wherein the profile for the user is defined based on the received data from the remote data source.

20. The vehicle of claim 16, wherein the instructions further cause the processor to define the profile for the user based on a history of past settings for one or more of the plurality of settings for each of the one or more features of the vehicle influencing the thermal environment inside the cabin of the vehicle.
